(19) United States
(12) Patent Application Publication
(10) Pub. No.: US 2018/0370054 A1
(43) Pub. Date: Dec. 27, 2018

(54) Multi-blade-drywall-cutter

(71) Applicant: Clay Patterson Baird, JR., Clarksville, IN (US)

(72) Inventor: Clay Patterson Baird, JR., Clarksville, IN (US)

(21) Appl. No.: 14/756,211

(22) Filed: Aug. 17, 2015

(51) Int. Cl. B26B 29/06

(52) U.S. Cl. CPC B26B 29/06; B26B 21/4075

(57) ABSTRACT

A multi-blade drywall cutter (MBDC) for making multiple simultaneous cuts to a piece of drywall. The MBDC has a first member pivotally connected to a second member, and first and second handles are attached to aid in use. The first member contains rollers to aid in using the cutting device and also a track that can be adjusted to vary the width to receive a board of various thicknesses. The second member has a plurality of cutting elements that may be located at various positions along the second member and secured for cutting.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable.

### BACKGROUND OF THE INVENTION

The invention relates to a multi-blade dry wall cutter. The cutter is designed to cut as many as ten dry wall rippers in one cutting pass which is used in drywall applications near windows, doors and soffits.

### BRIEF SUMMARY OF THE INVENTION

The multi-blade dry wall cutter includes a multi-blade drywall cutter (MBDC) which is pulled across a piece of drywall for cutting and neatly slicing drywall. Multi-Blade-Drywall-Cutter is designed to cut drywall rippers that are used to encase windows and or doors. The multi-blade can hold as many as ten razor cutting blades and has a (T-configuration) to allow the horizontal housing to function as a mobile machine and providing a foundation base for the vertical slide track to be locked in place for the function of cutting drywall. Two handles provide the needed pressure for both pulling and applying pressure downward when cutting and using the multi-blade drywall cutter. A first handle is attached to the horizontal housing located into the forward position for the pulling action. This allows the blades to be pulled at the front vertical edge of a 4′×8′ and or 4′×10′ drywall board. A second handle is removable. The second removable handle is located along the back edge of the vertical slide track that provides a downward pressure. The second handle is angled at 30 degrees toward the forward position of the first handle. The horizontal part of the housing, consists of a doubled three sided track housing. The track side includes a series of rollers. These series of rollers allow the multi-blade drywall cutting machine to roll along the top edge of a 4′×8′ and or 4′×10′ sheet of drywall board. The adjacent section of the three sided housing track side provides a spacing for the vertical slide tracks to be rotated at a center axis into a closed position. When in the closed position, the ‘M.B.D.C.’ machine forms into a (linear configuration). When one of the slide track is rotated at its lateral end point, into a (T-configuration), the multi-blade drywall cutter is ready for cutting drywall. The vertical part of the multi-blade drywall cutting machine housing includes a doubled slide track base. The track functions to hold the knife housing for insertion of cutting razor blades. The knife housing holding the cutting blades are positioned on the rear side of track. In operation the cutting blades provides a leading contact with the vertical edge of a 4′×8′ and or 4′×10′ sheet of drywall board. The further functions as a slide track in which a removable grip second handle can be added.

### BRIEF DESCRIPTION OF THE DRAWINGS

FIG. 1 is a figure of the present invention being used.

FIG. 2 is a plan view of the present invention.

FIG. 3 is a view of the present invention in a closed position.

FIG. 4 is another view of the present invention.

FIG. 5 is a view of the cutting members of the present invention.

FIG. 6 is an exploded view of a cutting member of FIG. 5.

FIG. 7 is a view of the locking mechanism for the cutting member of FIG. 5.

FIGS. 8a and 8b is an end view of the locking mechanism of FIG. 7.

FIG. 9 is an isometric view of the track and roller system of the present invention.

FIG. 10 is an isometric view of a handle attached to the track and roller system of FIG. 9.

FIG. 11 is a view of a removable handle of the present invention.

FIG. 12 is a view of a pivot pin used with the present invention.

FIG. 13 is a second view of the pivot in of FIG. 12 in use.

FIGS. 14a, 14b and 14c are views of an adjustment gage of the track and roller system of the present invention.

FIG. 15 is an isometric view of the scale system of the present invention.

### DETAILED DESCRIPTION OF THE SEVERAL VIEWS OF THE PRESENT INVENTION

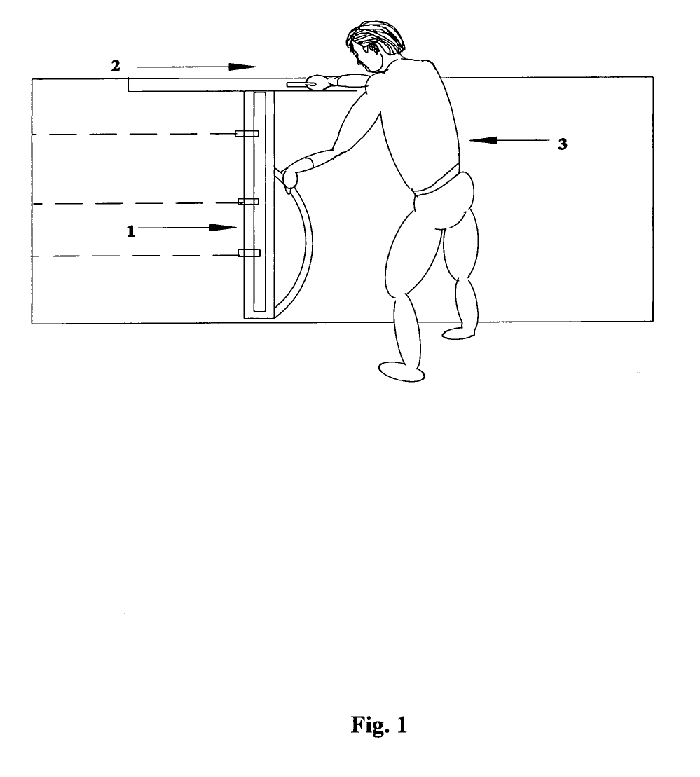

FIG. 1 is an illustration of the multi blade drywall cutter (MBDC) (1) which provides a pulling direction (2) of the MBDC (1) across a piece of drywall (3).

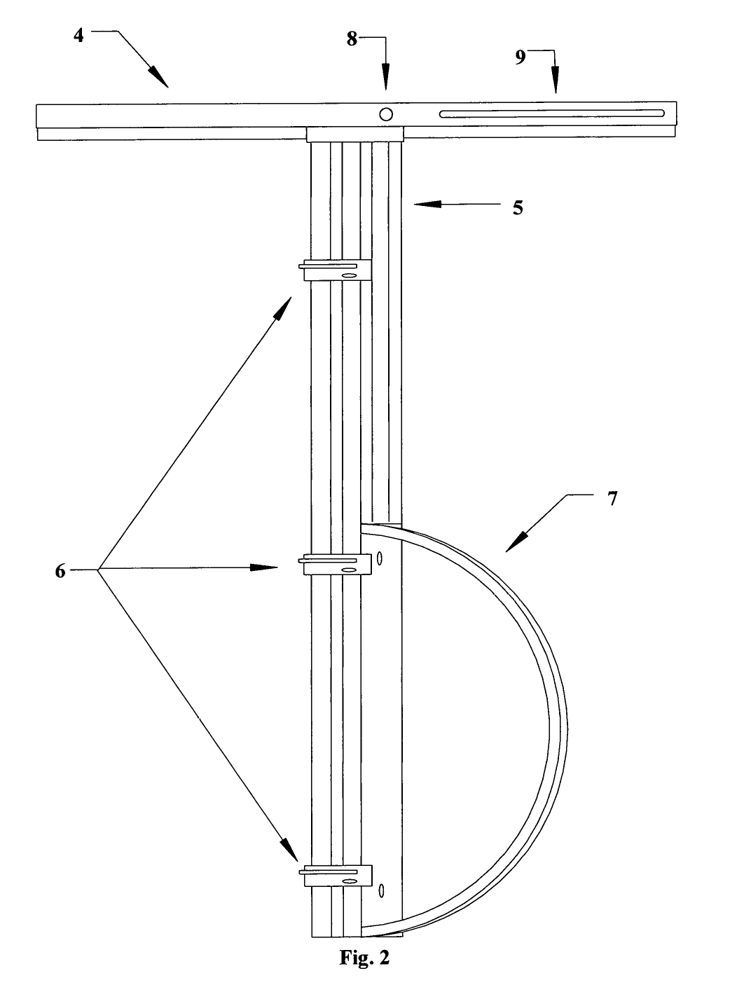

FIG. 2 is a plan view of the MBDC which has a general T-shape configuration (8) and has a first member (4) with a stationary handle (9) attached. The MBDC further has a second member (5) attached to the first member (4). The second member (5) has a plurality of cutting blades (6) spaced along the second member (5). The second member (5) further has a removable handle (7) attached and is configured to aid in pulling the MBDC by a user across a piece of drywall.

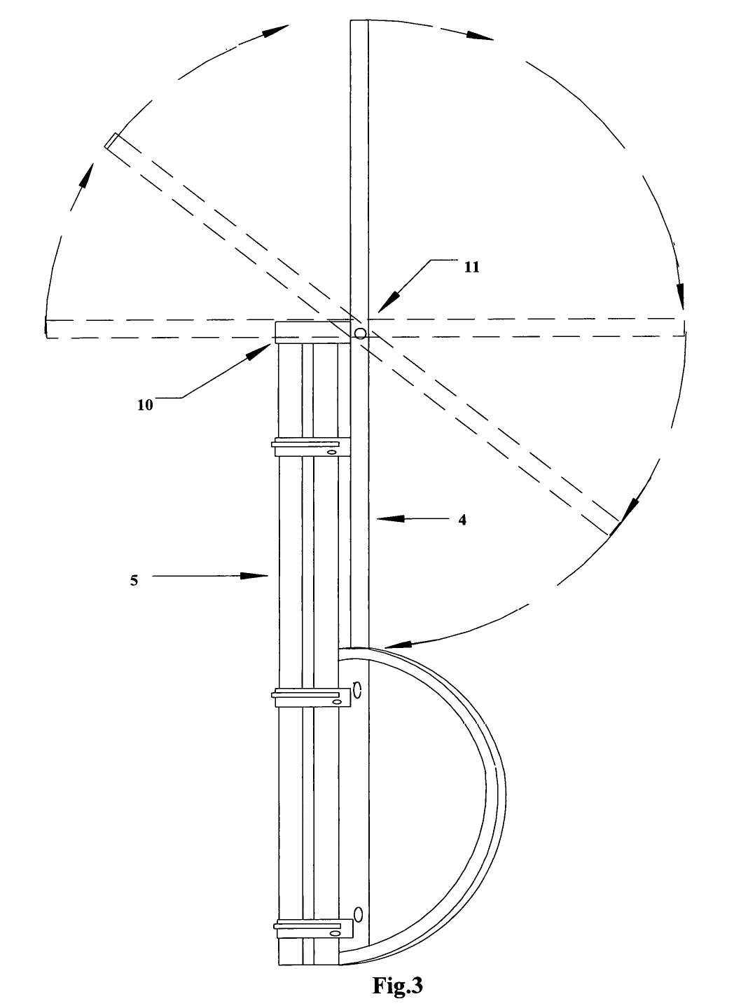

FIG. 3 shows the MBDC in a closed position (10), where the first member (4) is connected to the second member (5) by a pivot pin (11).

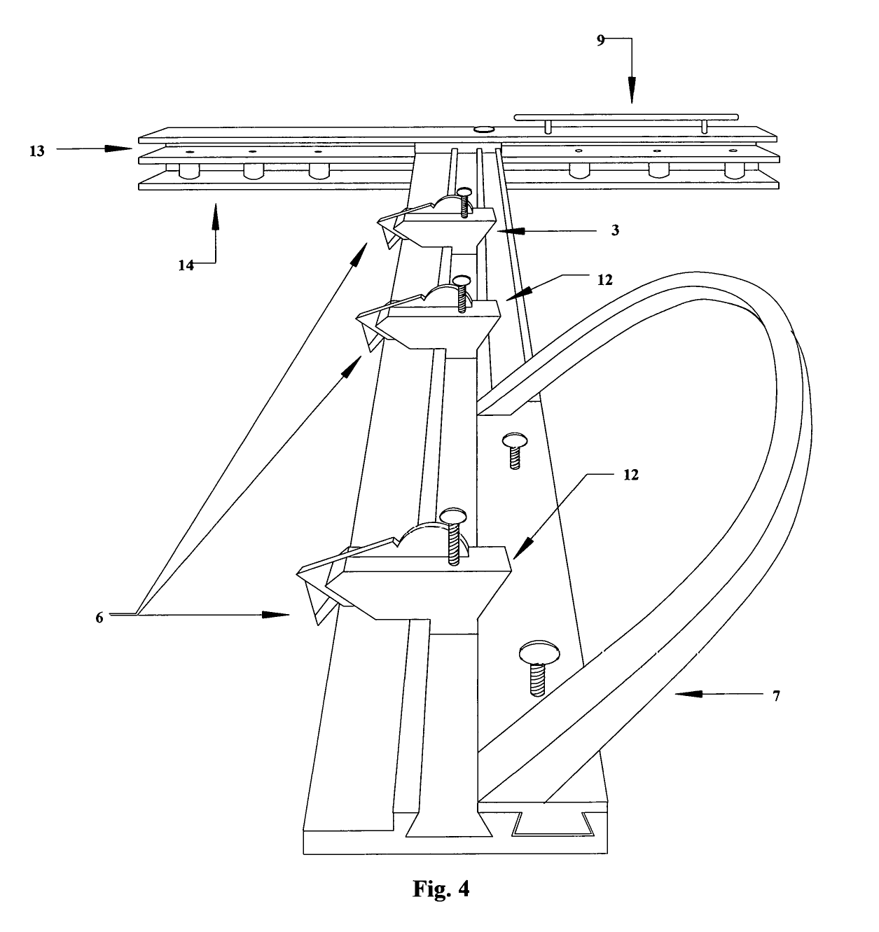

FIG. 4 is another view of the present invention of the MBDC with stationary handle (9) and removable handle (7). The first member (4) has a first track (13) with a retractable feature which will be explained in greater detail below. The first member (4) further has a second track (14). Further, the plurality of cutting blades (6) are spaced along the second member.

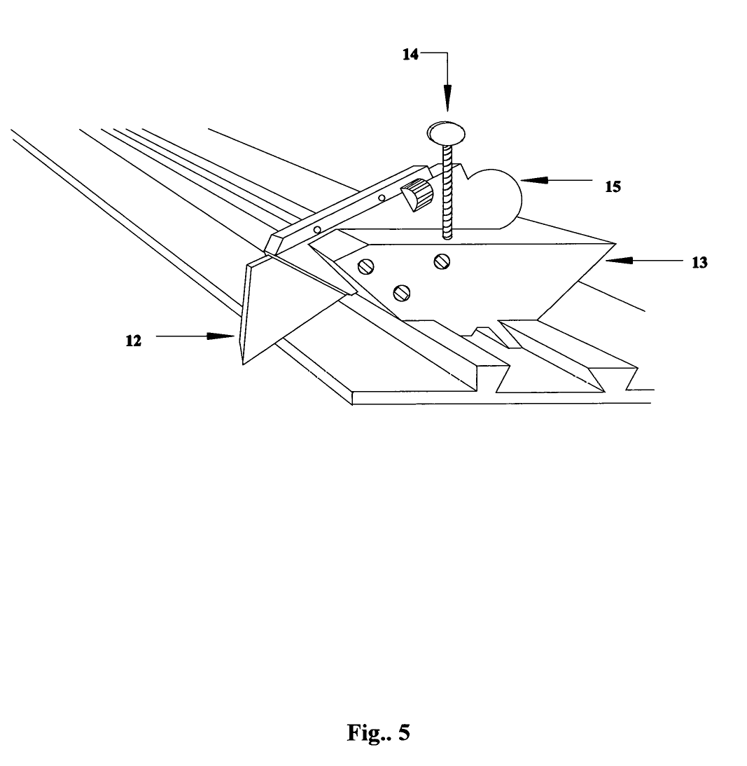

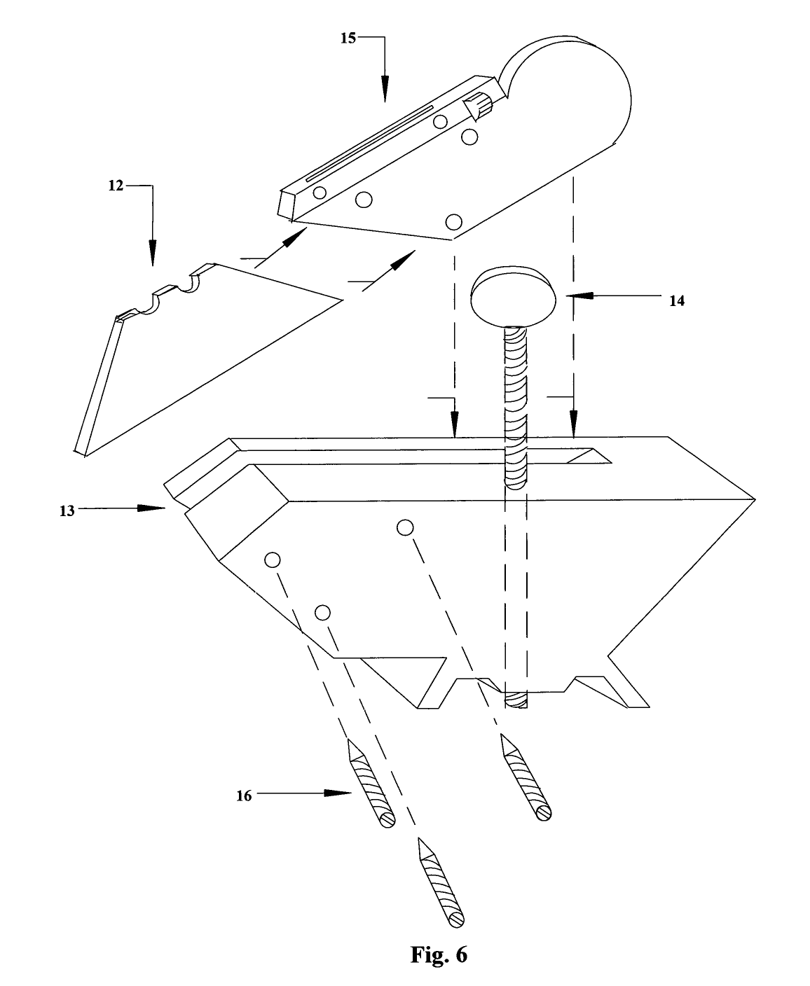

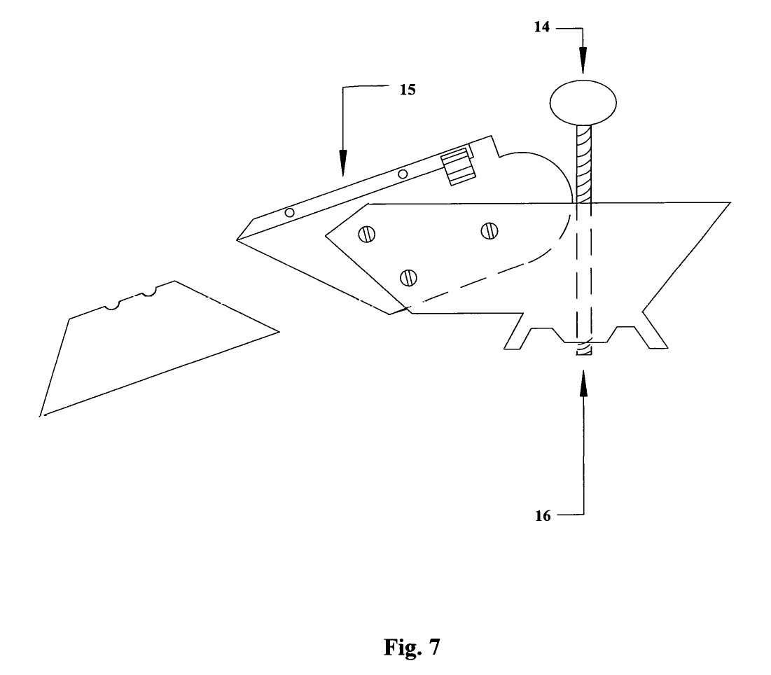

FIGS. 5-7 are more detailed views of the cutting blade (6) of the MBDC. The cutting blade (6) has a razor blade (12) contained within a knife housing (15). The knife housing (15) is further received in an insert housing (13). Further, a locking paddle screw (14) is received in the insert housing (13). FIG. 6 is an exploded view of the cutting blade. In addition to what is shown in FIG. 5, three screws (16) are used for locking the knife housing (15) within the insert housing (13). As shown in FIG. 7, the locking paddle screw (14) is received in a tapped out hole (16) of the insert housing (13).

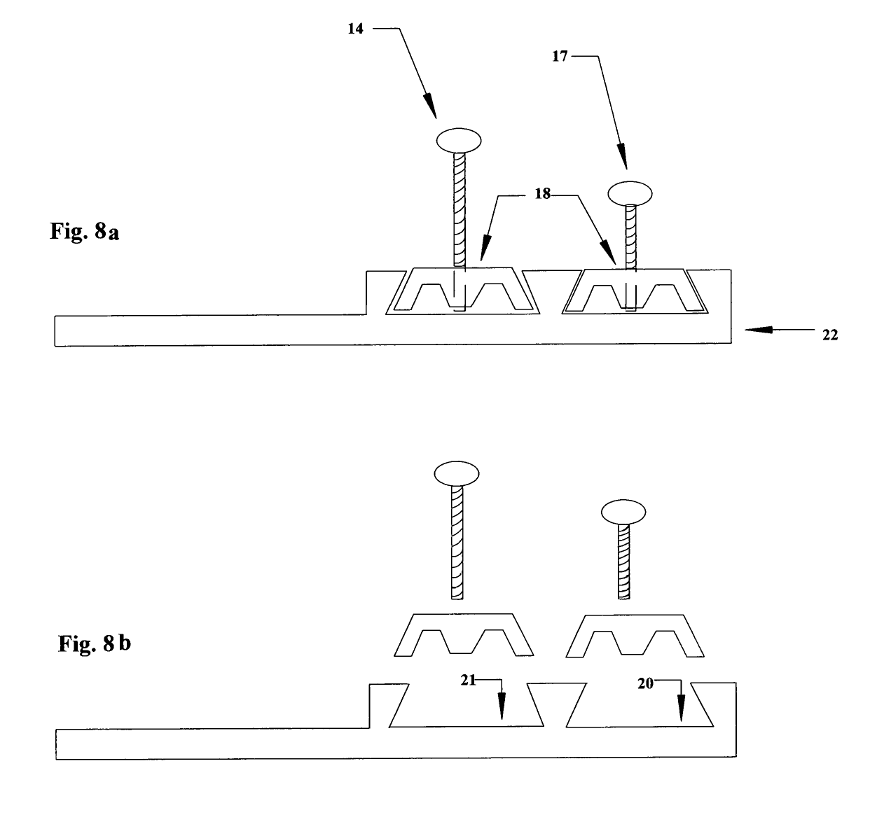

FIG. 8a provides an end view of the second member (5) of the MBDC. As shown, the locking paddle screws (14) and (17) are received in guide blocks (18) which are received in a slide track (21) for the insert housing (13) or in the slide track (20) for the removable handle (7). The back side of the slide track is represented by arrow (22). FIG. 8b is an end view of the second member (5) without the guide blocks (18) installed.

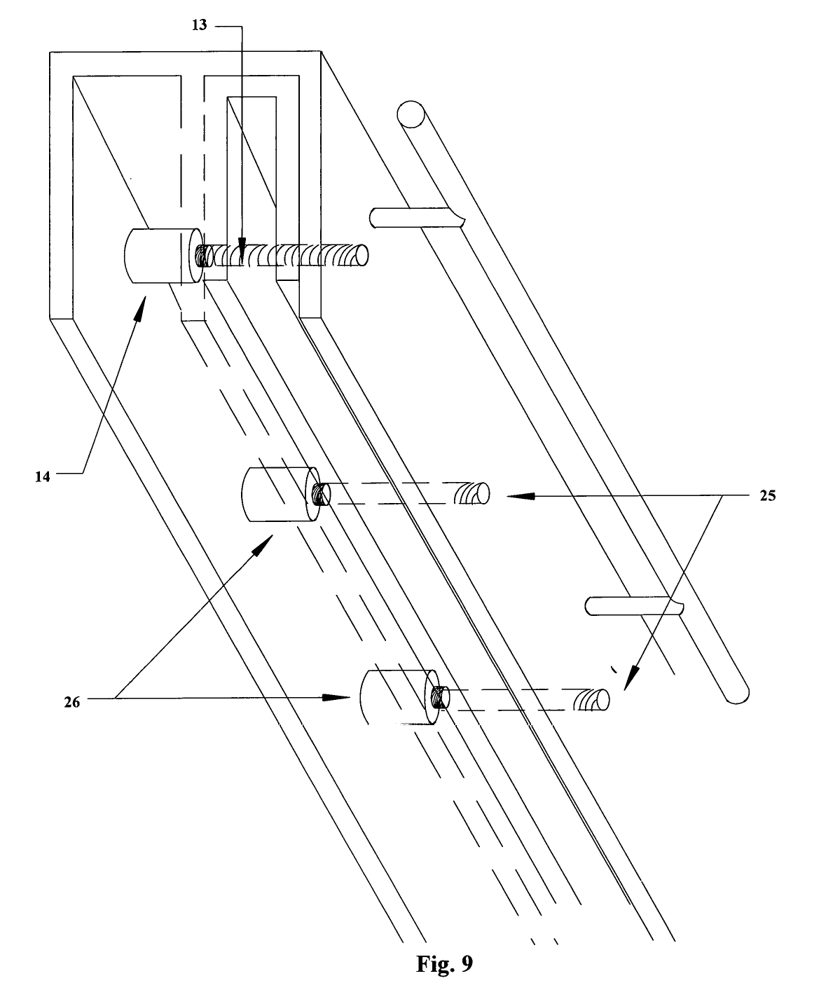

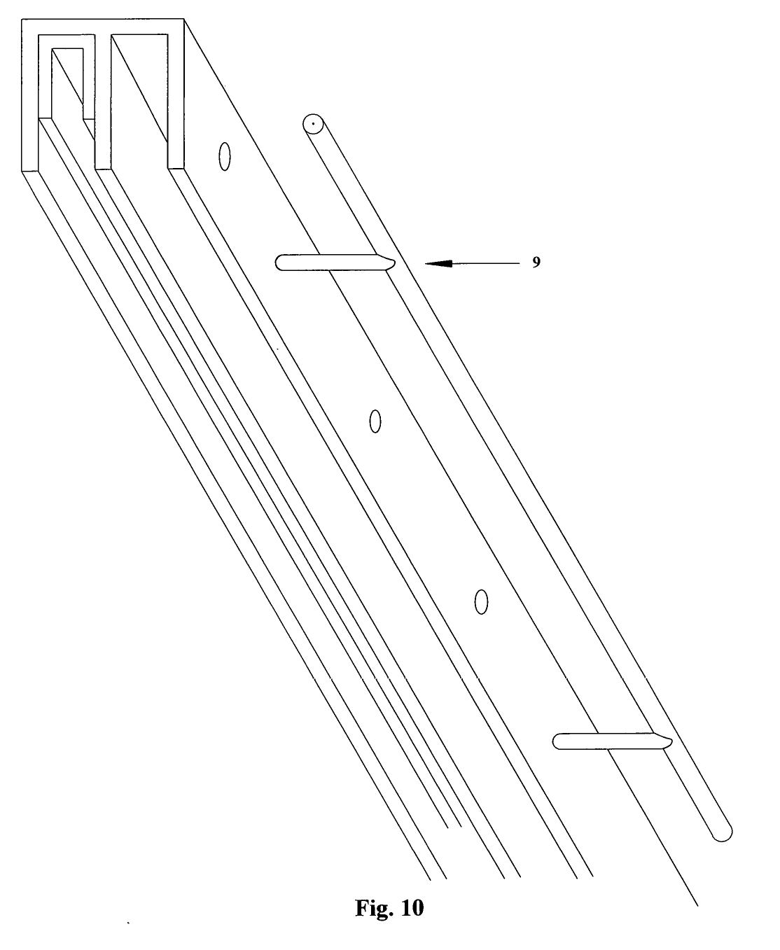

FIGS. 9 and 10 are more detailed views of the first member (4) of the MBDC. A series of rollers (26) as provided in the second track (14) and are held in place by assembly bolts (25). As shown in FIG. 10, the stationary handle (9) is mounted to the first member (4).

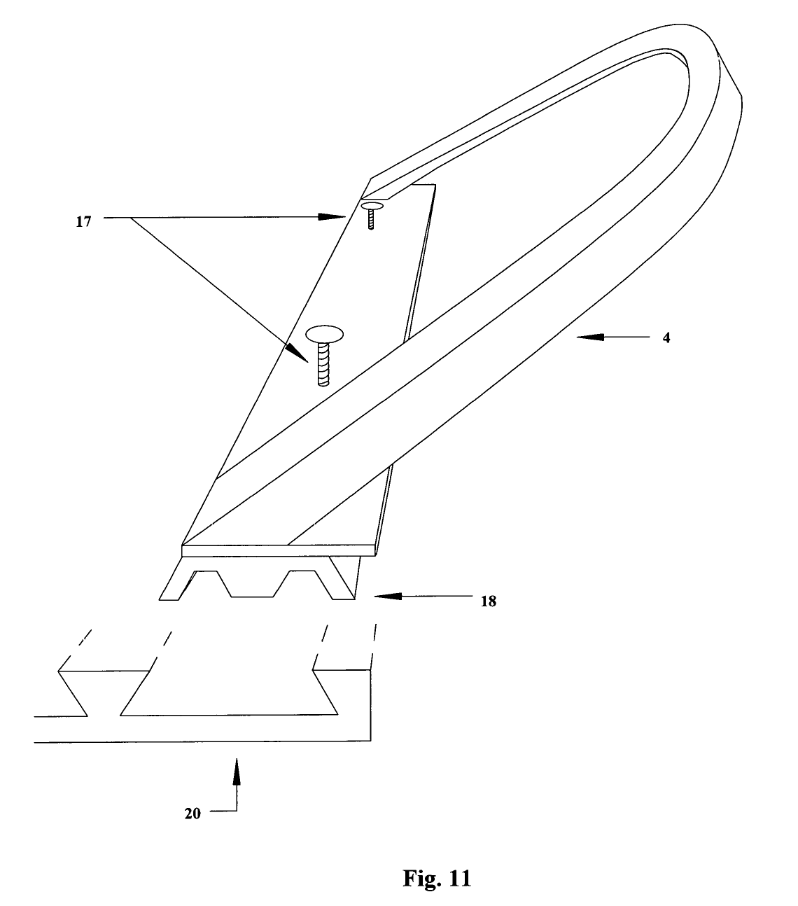

As shown in FIG. 11, paddle screws (17) as used to attach the removable handle (7) to the slide track (20). Guide block (18) is received in the slide track (20).

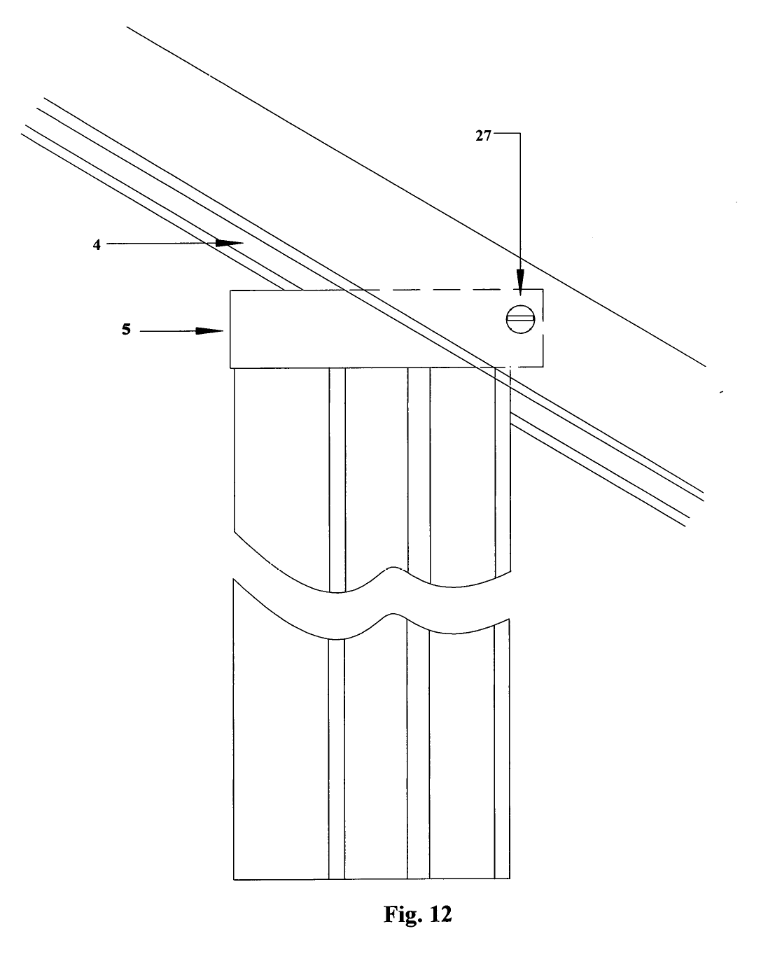

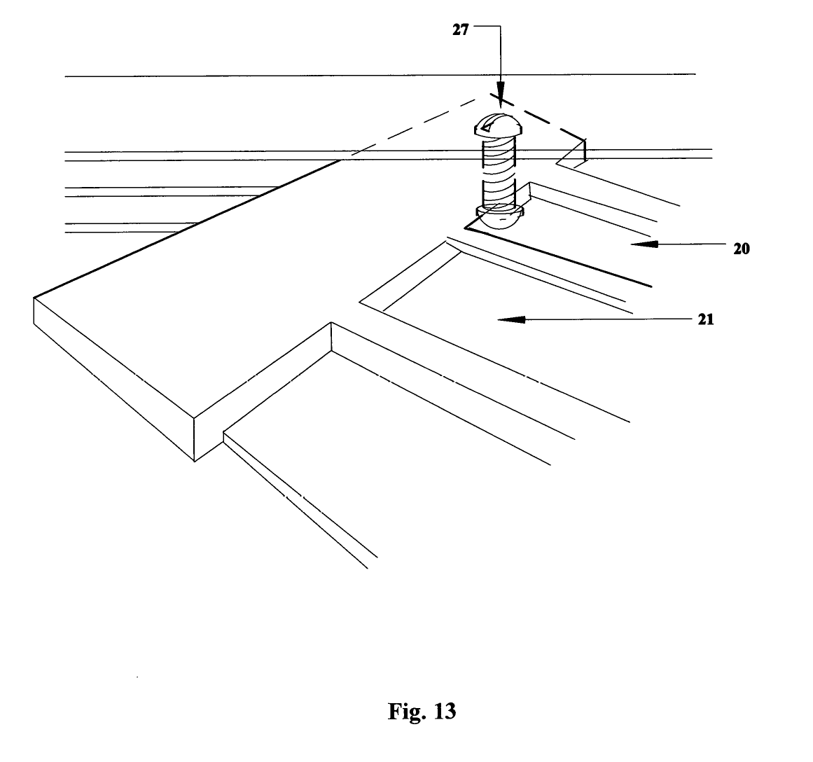

FIGS. 12 and 13 are more detailed views of the pivot connection between the first member (4) and second member (5) of the MBDC. The pivot pin (27) connects the first member (4) to the second member (5) and permits pivoting of the first member (4) with respect to the second member (5).

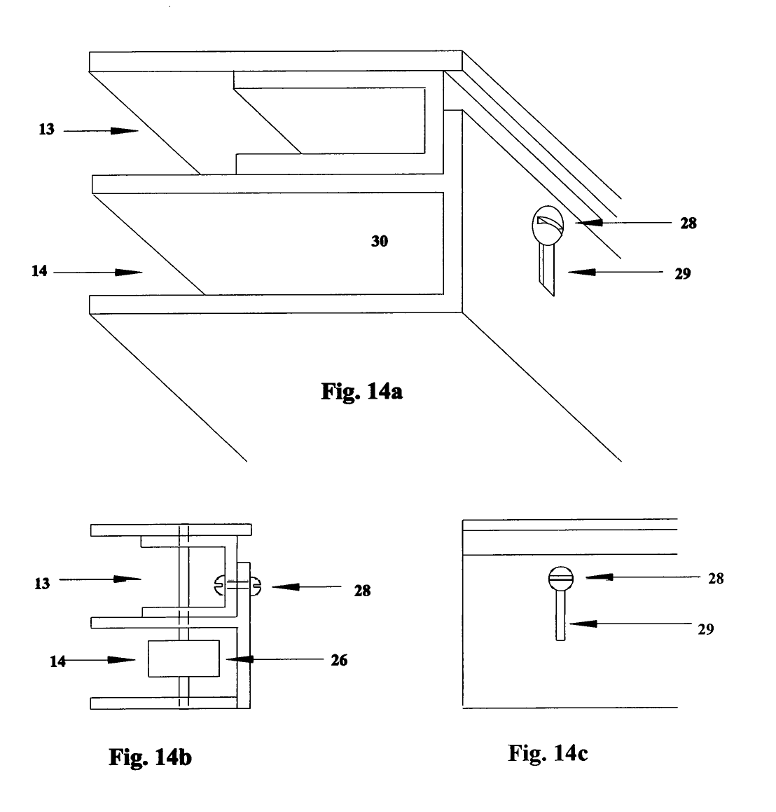

FIGS. 14a-14c provides a more detailed view of the adjustment gage of the first member. The first track (13) is moveable with respect to the second track (14) via screw (28) and slot (29) to vary the width (30) as needed.

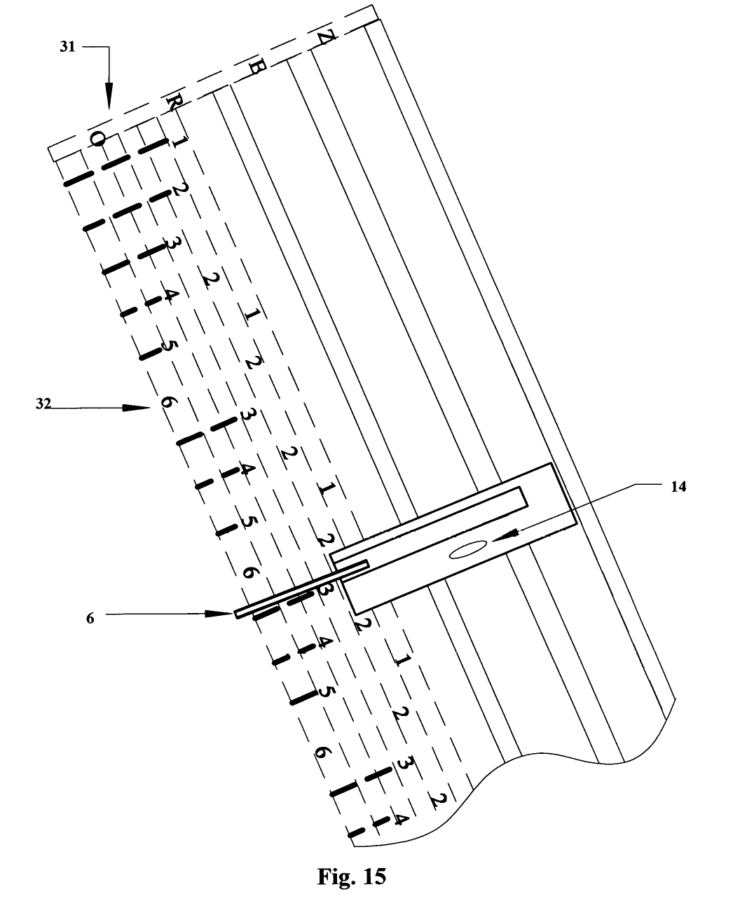

FIG. 15 provides a gage with markings (32). As shown the gage begins at point (31) and the cutting device (6) is able to move and be locked in place via the paddle screw (14).

1. (canceled)

2. I claim as being the inventor of a ‘MULTI-BLADE-DRYWALL-CUTTER’ which is designed to cut mass production of drywall rippers (upon a 4′×8′ and or 4′×10′ sheet of drywall board. It's designed to reduce labor time in hanging drywall in the commercial home industry. Also, it's light weight and when in its retractable closed position, it makes it very practical to carry to a job site

3. Unique drywall-ripper-number-system (1-6 inch) scale system allow as many as ten razor blade housings to be set within seconds.

4. Retractable (T-configuration) becomes a (linear-configuration) comparative to a 2″×4″×8′ STUD being transported to a job site.

5. Removable Handle and Knife-Blade-Insert-Housings makes its simple for storage.

6. Weight of MULTI-BLADE-DRYWALL-CUTTER is less than five pounds.

7. Match cuts or (scorings) are precise to allow the drywall-rippers to have uniform widths. After scoring the front side of a drywall board, simply by turning the drywall board around, the M.B.D.C. machine will make an exact match cuts.

8. Adjustable Gauge can provide various dimensional widths for ¼″, ½″ & ⅝″ drywall boards. The Horizonal Track that houses the series of spinning rollers, can slide (in & out) to make these adjustments. There are two slots located at the lateral ends of the M.B.D.C. machine which are locked by an Adjustable Screw.
